(19) United States
(12) Patent Application Publication
(10) Pub. No.: US 2008/0262986 A1
(43) Pub. Date: Oct. 23, 2008

(54) METHOD FOR TRAINING A CLASSIFIER

(76) Inventors: Ali Davar, Vancouver (CA); Mike Klaas, Vancouver (CA); Eric Brochu, Vancouver (CA)

Correspondence Address: NORMAN M. CAMERON, SUITE 1401 - 1166 ALBERNI STREET, VANCOUVER, BC, V6E 3Z3, CA

(21) Appl. No.: 12/113,598

(22) Filed: May 1, 2008

Related U.S. Application Data
(63) Continuation of application No. 11/319,941, filed on Dec. 29, 2005.

(51) Int. Cl. G06F 15/18

(52) U.S. Cl. 706/12

(57) ABSTRACT

A method for training a classifier which forms part of a search engine comprises: receiving a document submitted by an end user of the search engine at a server; creating a training set of documents, the training set including the document submitted by the end user; training the classifier using the training set; and paying an incentive to the end user for submitting the document.

### CROSS-REFERENCE TO RELATED APPLICATION

This application is a continuation of U.S. patent application Ser. No. 11/319,941 filed on Dec. 29, 2005, the complete disclosure of which is incorporated herein by reference.

### BACKGROUND OF THE INVENTION

1. Field of the Invention

This invention relates to a method for training a classifier.

2. Description of the Related Art

It is known to train a classifier using a training set of documents. The classifier analyses the documents in the training set and learns the parameters of a classification model. Once the classification model is learnt, the classifier may be used to analyze and extract information from a future set of documents. For example, the classifier may be used as part of an Internet search engine. When determining which documents may be relevant to a topic being searched the classifier uses the classification model. Accordingly, the robustness of the search results is generally limited by the documents in the training set.

### SUMMARY OF THE INVENTION

The present invention provides a novel method for training a classifier in which an end user of the classifier may submit documents which may be used in the training set.

In particular, there is provided a method for training a classifier which forms part of a search engine comprising: receiving a document submitted by an end user of the search engine at a server; creating a training set of documents, the training set including the document submitted by the end user; training the classifier using the training set; and paying an incentive to the end user for submitting the document.

### BRIEF DESCRIPTION OF DRAWINGS

The invention will be more readily understood from the following description of preferred embodiments thereof given, by way of example only, with reference to the accompanying drawings, in which:

FIG. 1 shows a distributed data processing system in which the invention may be implemented;

FIG. 2 shows the architecture of a processor which may be used to implement the present invention;

FIG. 3 shows a distributed data processing system in which an embodiment of the invention is implemented;

FIG. 4 shows a simplified registration process which may be used to implement the present invention;

FIG. 5 shows a registration form which may be used to implement the present invention;

FIG. 6 shows a simplified method for submitting a document to a server which may be used to implement the present invention;

FIG. 7 shows a login form which may be used to implement the present invention;

FIG. 8 shows the simplified operation of an application for submitting a document to a server which may be used to implement the present invention;

FIG. 9 shows the simplified operation of an application for training a classifier which may be used to implement the present invention; and

FIG. 10 shows a simplified block diagram depicting the method for training a classifier which may be used to implement the present invention.

### DESCRIPTION OF THE PREFERRED EMBODIMENTS

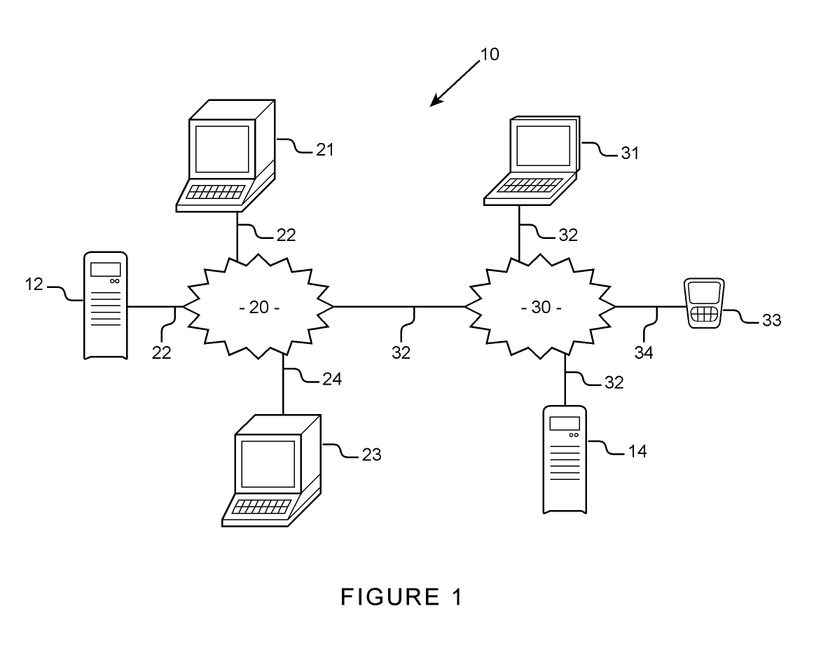

Referring to the drawings, and first to FIG. 1, a distributed data processing system 10 is shown. Data processing system 10 is given by way of example only, and is typical of a data processing system in which the present invention may be implemented. Data processing system 10 includes networks 20 and 30 which provide communication links between various processors. The communication links may be permanent connections, including but not limited to, wires 22 or fiber optic cables 32, and the communication links may be temporary connections, including but not limited to, connections made through telephone 24 or wireless communication 34. In data processing system 10, network 20 is the World Wide Web and network 30 is an intranet such as a wide area network (WAN) or a local area network (LAN). However, it will be understood by a person skilled in the art that data processing system 10 may further include additional networks and various different types of networks which have not been shown. It will also be understood by a person skilled in the art that many of the details provided above are by way of example only and are not intended to limited the scope of invention which is determined with reference to following claims.

Data processing system 10 includes a plurality of processors represented in FIG. 1 by servers 12 and 14 and user stations 21, 23, 31, and 33. Servers 12 and 14 and user stations 21, 23, 31 and 33 may be one of a variety of known processing devices, including but not limited to, mainframes, personal computers, personal digital assistants and cellular phones. It will further be understood by a person skilled in the art that data processing system 10 may further include additional processors and various different types of processors which have not been shown.

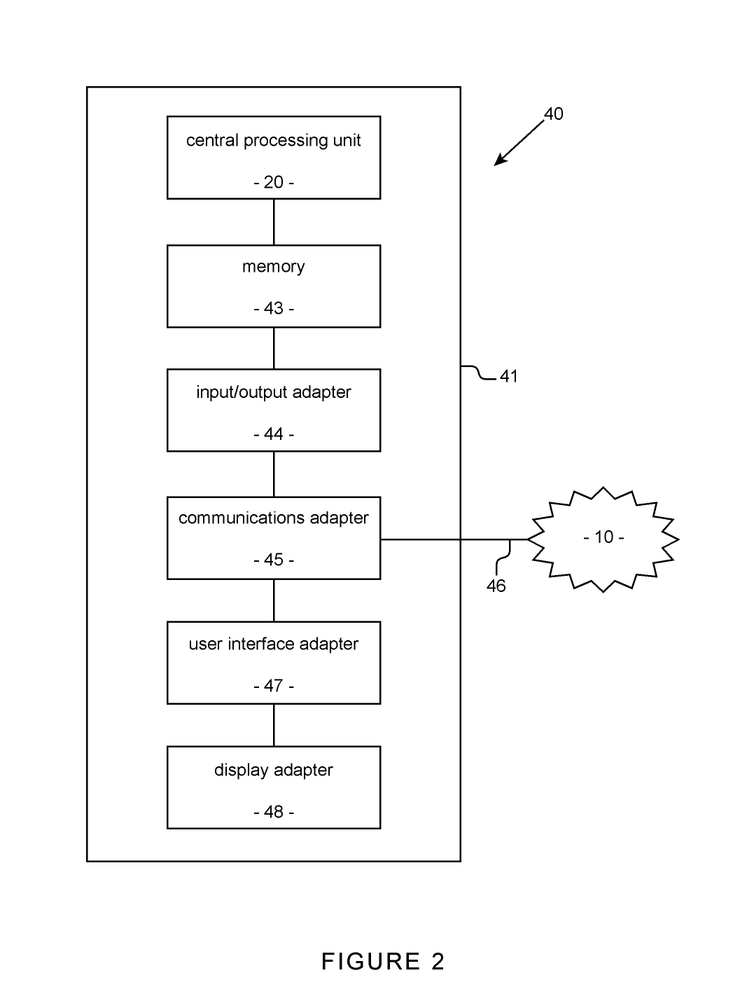

FIG. 2 illustrates a typical architecture 40 of a processor in the data processing system 10. An internal bus system 41 interconnects a central processing unit (CPU) 42 with memory 43, an input/output adapter 44, a communications adapter 45, a user interface adapter 47, and a display adapter 48. The memory 43 may include one or more types of random access memory (RAM) and read only memory (ROM). The memory 43 may also include one or more types of volatile and non-volatile memory. The input/output adapter 44 may support various input/output devices, including but not limited to, a printer, a disk unit, and an audio unit. The communications adapter 45 may provide access to a communication link 46 such as a fiber optic cable which may connect the CPU 42 to the distributed data processing system 10. The user interface adapter 47 may support various user interface devices, including but not limited to, a touchscreen, a keyboard, and a mouse. The display adapter 48 may support various display devices such as a monitor. FIG. 2 is provided by way of example only and is in no way intended to imply architectural limitations to any processor in data processing system 10. Furthermore, it will be understood by a person skilled in the art that the hardware of FIG. 2 may vary between processors.

In addition to being implemented on a variety of hardware platforms, the present invention may also be implemented on a variety of software platforms. Typically, an operating system is used to control program execution within a processor. However, the operating system used may vary between processors. For example, in FIG. 1, server 12 may run on a Linux® operating system, while server 14 runs on a Solaris® operating system and user station 21 runs on a Microsoft® operating system. Similarly, other processors in data processing system 10 may run on other operating systems. A processor in data processing system 10 may further support a typical browser application or another suitable application for retrieving HTTP documents in a variety formats.

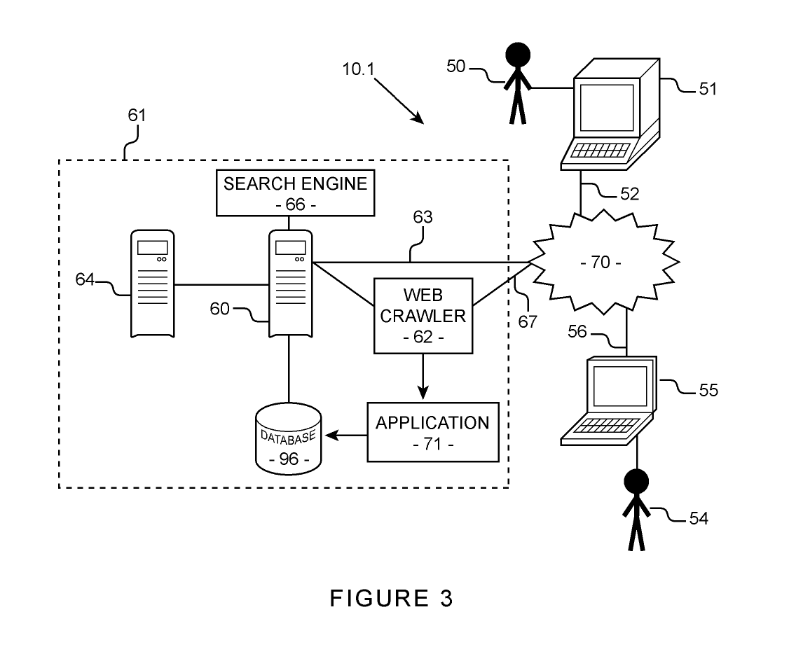

A preferred embodiment the present invention is implemented in distributed data processing system 10.1, which is best shown in FIG. 3. A server 60 belonging to a search engine company 61 is connected to the Internet 70 via a communications link 63. The server 60 or another processor 64 operating in co-operation with the server 60 supports a Web crawler 62. The Web crawler 62 crawls the Internet 70 by following hyperlinks 67 and retrieves documents from the Internet 70. The documents may be found on Web sites, or in proprietary intranets or proprietary databases. The documents may be in the form of Web pages, text files, image files, audio files and other various formats and types of files. The documents gathered by the Web crawler 62 are parsed by a suitable application 71 and stored in an Internet documents database 96 supported by the server 60 or another processor 64 operating in co-operation with the server 60. The server 60 or another processor 64 operating in co-operation with the server 60 also supports a search engine 66. In this embodiment of the invention, the search engine 66 includes a plurality of classifiers. Each classifier is specific to a topic which may be searched by an end user of the search engine 66.

User stations 51 and 55 are connected to the Internet 70 via communication links 52 and 56 respectively. End users 50 and 54 communicate with the server 60 via user stations 51 and 55 respectively. End users 50 and 54 may register themselves with the server 60 so that they may submit documents to the server 60. The documents submitted by the end users 50 and 54 may be used to create a training set of documents for training a classifier of the search engine 66. End users 50 and 54 may also register their user stations 51 and 55 with server 60. The distributed data processing system 10.1 is thereby created. In this example, distributed data processing system 10.1 comprises the server 60 and user stations 51 and 55. A classifier may be trained in parallel within the distributed data processing system 10.1.

The process of registering with the server 60 is substantially equivalent for both end user 50 and end user 54. Accordingly, although the following discussion is limited to end user 50, it is substantially applicable to end user 54.

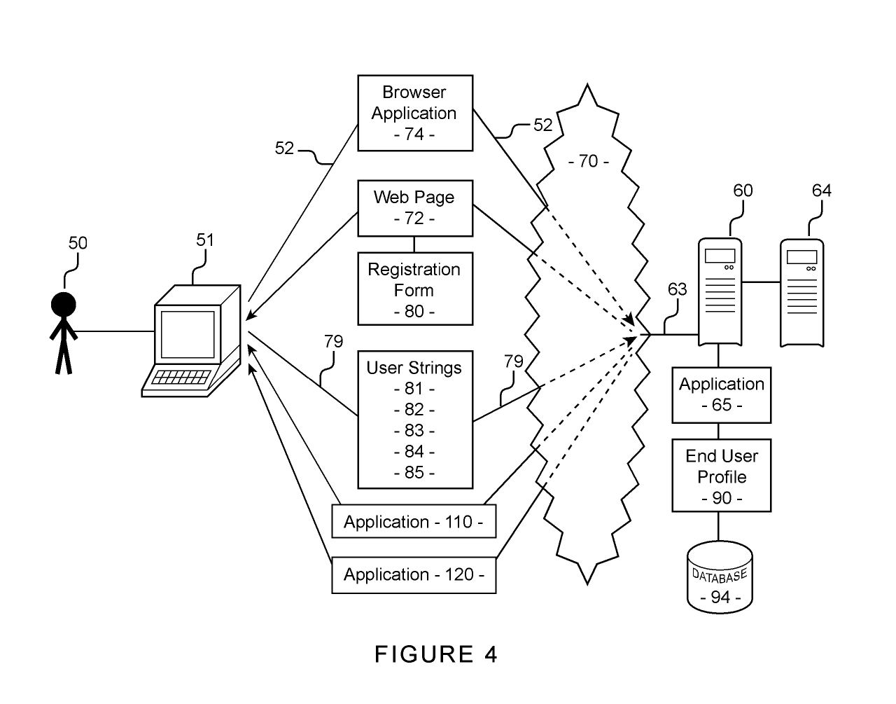

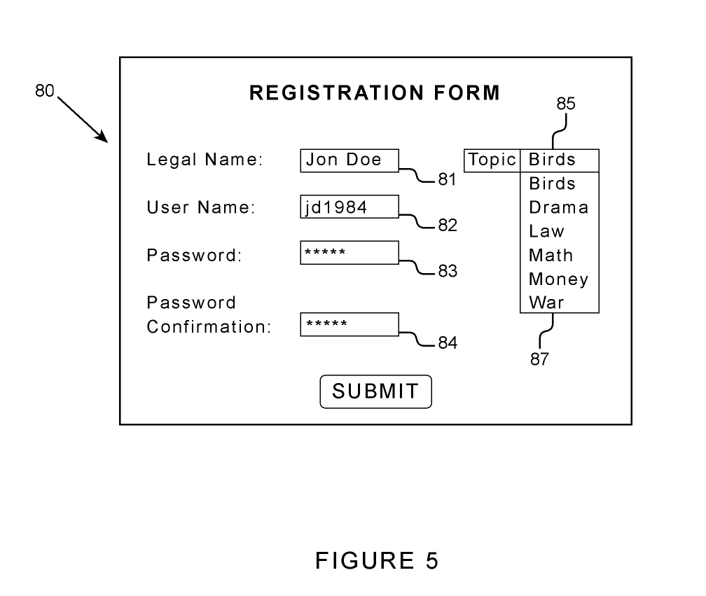

End user 50 registers with the server 60 as best shown in FIG. 4. User stations 51 is connected to the Internet 70 via communication links 52 and the server 60 is connected to the Internet via communications link 63. The end user 50 goes online via the user station 51 by operating a browser application 74 or another suitable application supported by the user station 51, that allows the end user to surf the Internet. The end user 50 retrieves a Web page 72 from the server 60. The Web page 72 supports a registration form 80. The registration form 80, which is best shown in FIG. 5, appears on a display device such as a monitor that is supported by the user station 51. The end user 50 enters the required registration strings 81, 82, 83, 84, and 85 into the registration form 80 using user interface devices such as a keyboard and a mouse. Referring back to FIG. 4, the end user 50 submits the registration strings 81, 82, 83, 84, and 85 to the server 60 in an appropriate secure format such as an HTTP post 79. However, it will be understood by a person skilled in the art that in other embodiments of the invention, the registration strings may submitted by other means such as an encrypted HTTP post or the registration strings may be inputted directly into the server.

As shown in FIG. 5, in this embodiment of the invention, the end user 50 is required to input the following registration strings into the registration form 80: a legal name string 81; a user name string 82; a password string 83; and a password confirmation string 84. The end user 50 is also required to select a topic string 85 from the list of topic strings 87 provided on the registration form 80. The topic string 85 defines a topic which the end user 50 desires to search in the future. It is noted however that in other embodiments of the invention an end user may be required to input additional information into a registration form. The registration form 80 of FIG. 5 is given by way of example only and is in no way intended to limit the scope of information that may be required to be inputted into a registration form in alternate embodiments of the invention.

Referring back to FIG. 4, after the registration strings 81, 82, 83, 84, and 85 are received by the server 60, a suitable application 65 analyses the registration strings 81, 82, 83, 84, and 85 and creates an end user profile 90. The end user profile 90 is stored within an end user database 94 supported by the server 60 or another processor 64 working in co-operation with the server 60. The server 60 sends a document submission application 110 and a training application 120 to the end user 50 via the user station 51. The end user 50 may download and install the applications on the user station 51. The document submission application 110 allows the end user 50 to submit a document to the server 60. The training application 120 allows the user station 51 to train a classifier supported by the server 60.

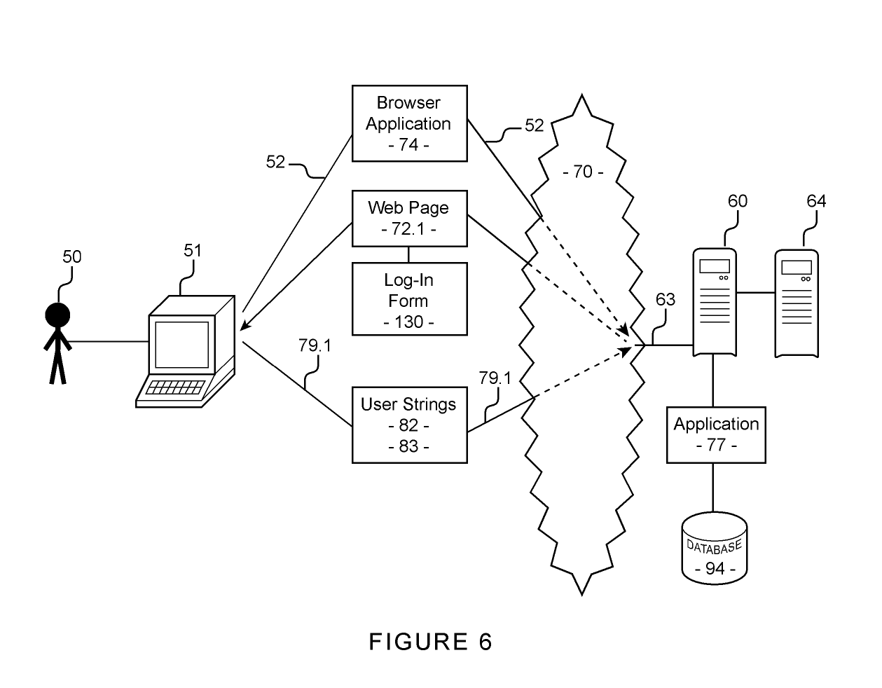

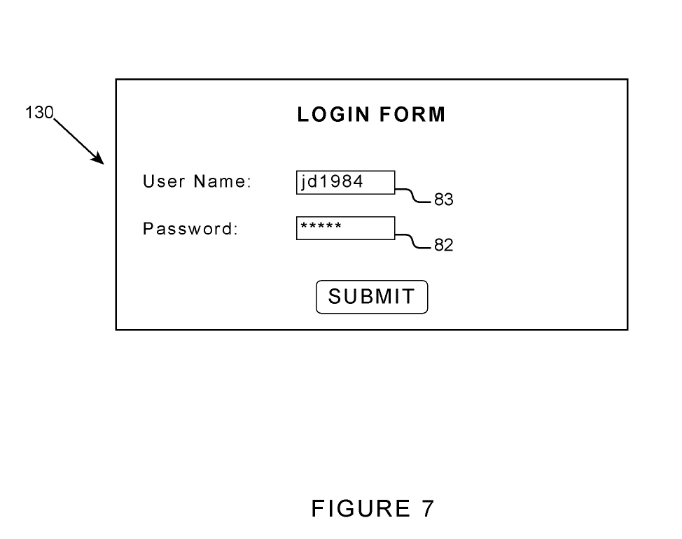

The process through which the end user 50 submits documents to the server 60 is best shown in FIG. 6, according to this embodiment of the invention. User station 51 is connected to the Internet 70 via communication links 52 and the server 60 is connected to the Internet via communications link 63. The end user 50 goes online via the user station 51 by operating a browser application 74 or another suitable application supported by the user station 51, that allows the end user to surf the Internet. The end user 50 retrieves a Web page 72.1 containing a log-in form 130 from the server 60. The login form 130 is best shown in FIG. 7, according to this embodiment of the invention. The end user 50 inputs their user name string 82 and password string 83 into the login form 130 using user interface devices such as keyboard and a mouse. Referring back to FIG. 6, the user name string 82 and password string 83 are submitted to the server 60 in an appropriate secure format such as an HTTP post 79.1 In other embodiments of the invention an encrypted HTTP post may be used.

The server 60 receives the user name string 82 and password string 83 and a suitable application 77 supported by the server 60 confirms the identity of the end user 50 by cross-referencing the user name string 82 and password string 83 against the end user database 94. Once the identity of the end user 50 is confirmed the end user 50 is logged on the server 60 and the end user 50 is able to submit documents to the server 60 using the document submission application 120.

As the end user 50 surfs the Internet, and when the end user 50 comes across a document that the end user 50 determines to be relevant to the topic defined by the topic string 85 selected by the end user 50 during the registration process, the end user 50 may operate the document submission application 110 and submit the document to the server 60. However, it will be understood by a person skilled in the art that in other embodiments of the invention a document submission application may not be required and an end user may be able to submit documents to the server by alternate suitable means such as WWW or HTTP protocols.

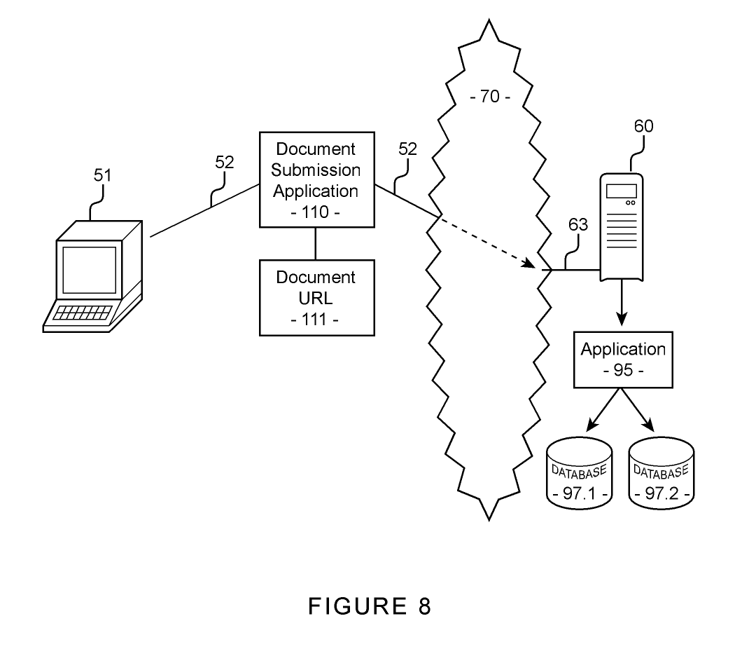

Operation of the document submission application 110 is best shown in FIG. 8, according to this embodiment of the invention. The document submission application 110 establishes a connection between the user station 51 and the server 60 via the Internet 70 and communication links 52 and 63. The document submission application 110 sends the URL 111 of the document being submitted to the server 60. The server 60 downloads the document, a suitable application 95 parses the document and adds the document to an appropriate submitted documents database 97.1 or 97.2. The appropriate submitted documents database 97.1 or 97.2 is selected by the document submission application 110 based on the topic string 85 selected by the end user 50 during the registration process. As such, documents in the submitted documents database 97.1 or 97.2 have been determined by the end user 50 to be relevant to the topic defined by topic string 85. The documents submitted by the end user 50 may used create a training set of documents to train a classifier supported by the server 60.

The training set is made up of a plurality of documents. Each document relevant to the topic being classified is labeled +1 and all the other documents are labeled −1. The documents labeled +1 are taken from the submitted documents database 95 which contains the documents submitted by the end user 50 and are representative of documents that the end user 50 determined to be relevant to the topic defined by the topic string 85 selected by the end user 50 during the registration process of FIG. 4. The documents labeled −1 are randomly selected from the Internet documents database 96 and are representative of documents found on the Internet.

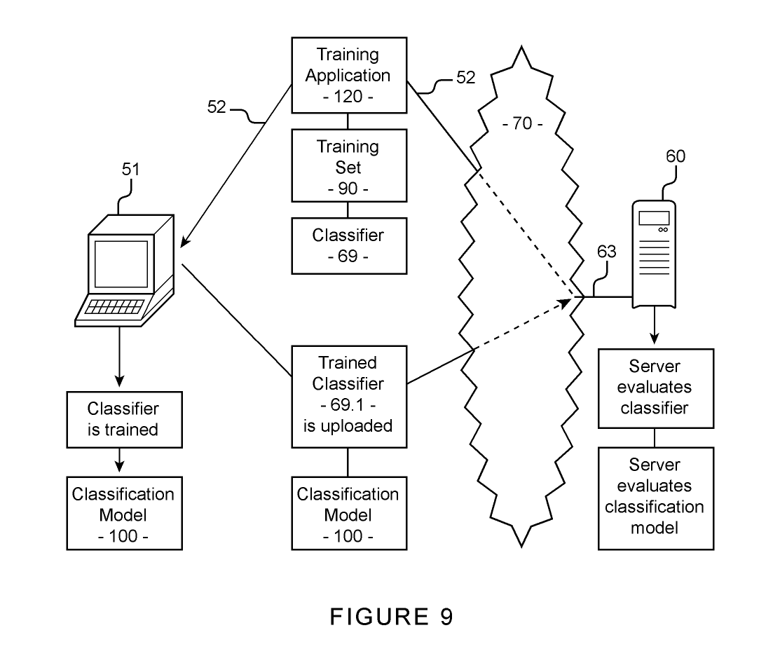

Referring back to FIG. 3, in this embodiment of the invention, a classifier of the search engine 66, supported by the server 60 may be trained at the server 60. Alternatively, the classifier may be trained on user stations 51 or 55 through the operation of the training application 120. Referring to now to FIG. 9, operation of the training application 120 to train a classifier at the user station 51 is best shown, according this embodiment of the invention. The training application 120 establishes a connection between the user station 51 and the server 60 via the Internet 70 and communication links 52 and 63. The training application sends a training set 90 and a classifier 69 to the user station 51 from the server 60. The classifier 69 is trained at the user station 51 using methods known in the art. In this embodiment of the invention, the classifier analyses the documents in the training set 90, which includes documents which were submitted by the end user 50. The classifier uses the training set 90 to learn the parameters of a classification model 100.

The trained classifier 69.1 and classification model 100 are uploaded onto the server 60 from the user station 51 where they may be evaluated. The classification model 100 is learnt the trained classifier 69.1 may be used as part of the search engine 66, shown in FIG. 3, to determine whether future unseen documents are relevant to a topic. More specifically, the trained classifier 69.1 and classification model 100 may be used to determine how relevant future unseen records are to a topic. The trained classifier 69.1 and classification model 100 may be used a ranking mechanism to rank search results or a restricting mechanism to prune irrelevant results. In this embodiment of the invention, the trained classifier 69.1 and classification model 100 are used as the search engine 66 by the search engine company 61 shown in FIG. 3.

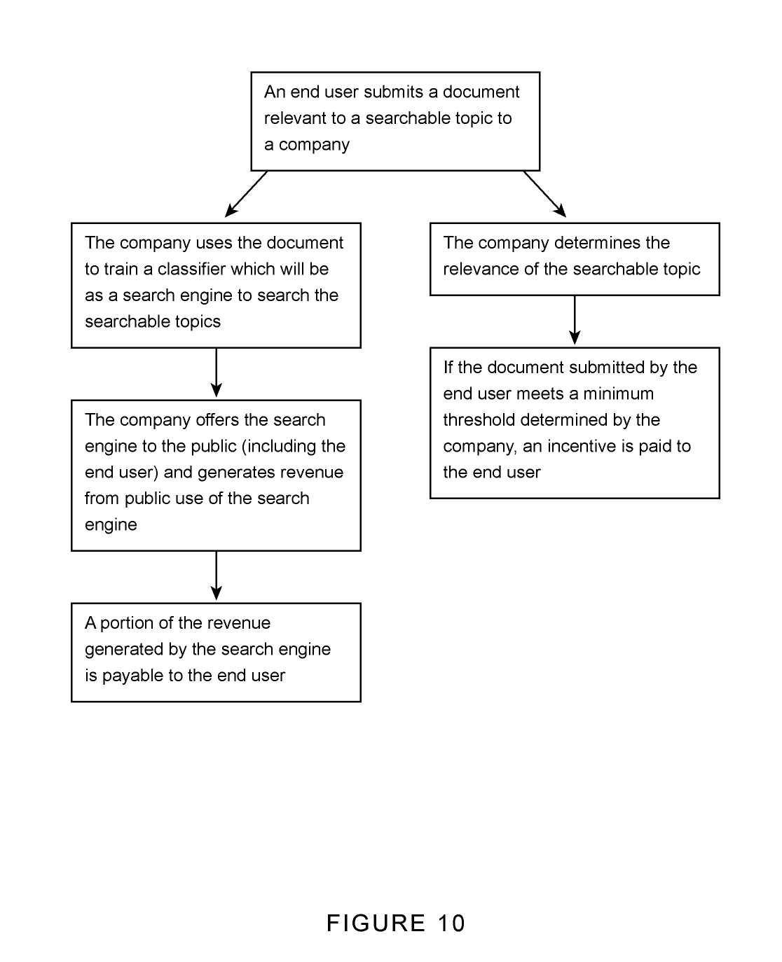

However, the accuracy of the classification model 100 developed, and by extension the usefulness of the search engine 66, is dependent on the relevance of the documents in the training set labeled +1. In other words the relevance of the documents submitted by the end user 50 to the topic string 85 being searched. As such, in the present invention an incentive is offered to the user 50 to submit relevant documents. The incentive scheme is best shown is FIG. 10.

The incentive may be monetary or alternative incentive schemes such as reward points or rebates may be used. In this embodiment of the invention, the incentive is a portion of advertising revenue generated by the search engine company, and the incentive is based on the relevance of the documents submitted by the end user 50. The relevance of a document may be measured through a cross-validation process. For example, a subset of the documents submitted by an end user is used to train a validation classifier using a small subset of a training set. The relevance of each submitted document is evaluated by classifying the submitted documents that were not used in training of the validation classifier, and measuring the fraction that were assigned a ranking above a threshold. By iterating this process using different subsets of the training set, scores may be assigned for each document based on the performance of the classifiers to which it participated in validation training. An amount payable to a user may be derived from the total scores of the documents submitted by the user.

It will be understood by someone skilled in the art that many of the details provided here are by way of example only and can be varied or deleted without departing from the scope of the of the invention as set out in the following claims.

What is claimed is:

1. A method for training a classifier which forms part of a search engine, the method comprising:
receiving a document submitted by an end user of the search engine at a server;
creating a training set of documents, the training set including the document submitted by the end user;
training the classifier using the training set; and
paying an incentive to the end user for submitting the document.

2. The method as claimed in claim 1, wherein the classifier is a ranking mechanism for ranking search results.

3. The method as claimed in claim 1, wherein the classifier is a restricting mechanism pruning irrelevant results.

4. A method for training a classifier which forms part of a commercial Internet search engine, the method comprising:
receiving a document submitted by an end user of the search engine at a server;
creating a training set of documents, the training set including the document submitted by the end user;
training the classifier using the training set; and
paying a portion of advertising revenue generated by the internet search engine to the end user for submitting the document.

5. The method as claimed in claim 4, wherein the classifier is a ranking mechanism for ranking search results.

6. The method as claimed in claim 4, wherein the classifier is a restricting mechanism pruning irrelevant results.
